(19) United States
(12) Patent Application Publication
(10) Pub. No.: US 2003/0051084 A1
(43) Pub. Date: Mar. 13, 2003

(54) Peripheral device having a built-in device driver

(76) Inventor: Allan Rosen, Mt. Laurel, NJ (US)

Correspondence Address: HEWLETT-PACKARD COMPANY, Intellectual Property Administration, P.O. Box 272400, Fort Collins, CO, 80527-2400, US

(21) Appl. No.: 10/279,653

(22) Filed: Oct. 23, 2002

Related U.S. Application Data
(63) Continuation-in-part of application No. 09/952,558, filed on Sep. 13, 2001.

(51) Int. Cl. G06F 13/12

(52) U.S. Cl. 710/72

(57) ABSTRACT

A peripheral device contains a built-in device driver that is provided to one or more computers coupled to the peripheral device. The peripheral device is first coupled to a computer. The peripheral device notifies the computer that the peripheral device contains a built-in device driver that can be communicated to the computing device. The peripheral device communicates the device driver to the computing device in response to a request from the computing device to transmit the device driver. The peripheral device may periodically update its built-in device driver by downloading an updated device driver from a server or other device.

### CROSS-REFERENCE TO RELATED APPLICATIONS

The present application is a Continuation-In-Part of U.S. patent application Ser. No. 09/952,558, filed Sep. 13, 2001, which is incorporated by reference in its entirety herein.

### TECHNICAL FIELD

The present invention relates to peripheral devices and, more particularly, to methods and systems for storing a device driver in a peripheral device and providing the device driver to a computer or other device coupled to the peripheral device.

### BACKGROUND

Advances in technology have resulted in commercially available devices having faster speed, increased performance, and improved features. A wide range of computer-related devices (also referred to as peripheral devices) are commercially available, ranging from relatively simple devices such as a mouse to more sophisticated devices such as digital cameras and laser printers having many features and expandable options.

When configuring a peripheral device to work with a particular computing system, a device driver associated with the peripheral device is often installed on the computing system. A device driver is a program that controls one or more devices. The device driver functions as a translator between the peripheral device and the application programs on the computing system that use the peripheral device. Each peripheral device has its own set of commands or operations that are known by its device driver. However, the application programs on the computing system typically issue generic commands (such as change paper size, scan an image, or send a document). The device driver translates these generic commands into specific commands that are understood by the peripheral device.

In existing systems, when configuring a peripheral device to work with a particular computing system, the user of the computing system may be required to install a device driver from a storage media (such as a CD-ROM or a diskette) that is provided with the peripheral device. For a novice computer user, or a user with little or no experience configuring computers and peripheral devices, installing a device driver for a peripheral device may be a difficult task. For a user that simply wants to connect the peripheral device to the computing system and begin using the peripheral device, requiring the installation of a device driver prior to using the device is a tedious and frustrating task.

Another option that may be used by existing systems requires a user to download a device driver from an online source, such as a peripheral device manufacturer's web page. If the peripheral device is coupled to a new computer system that is being configured, the computer system may not yet have access to the Internet or other data communication network. Additionally, requiring a user to locate the proper web page and the correct device driver can be time-consuming and frustrating to a novice computer user.

In other systems, the computing system may have one or more device drivers pre-installed by the manufacturer of the computing system. In this situation, the user is required to locate and install an appropriate device driver for the attached peripheral device. Depending on when the device drivers were pre-installed on the computer, a device driver for the particular peripheral device may not have been pre-installed on the computer if the peripheral device is new. Thus, the pre-installed device drivers may not be appropriate for the peripheral device attached to the computer.

The invention described herein addresses these problems by providing a peripheral device having a built-in device driver that can be communicated to a computer system coupled to the peripheral device, thereby simplifying the configuration of the peripheral device and the computer system.

### SUMMARY

A peripheral device contains a built-in device driver that can be provided to a computing device coupled to the peripheral device. By automatically communicating the built-in device driver to the computing device, a user of the computing device is not required to locate, install, or configure a device driver before using the peripheral device.

In a particular embodiment, a peripheral device notifies a computing device that the peripheral device contains a built-in device driver that can be communicated to the computing device. The peripheral device then communicates the device driver to the computing device.

In another embodiment, the peripheral device communicates the device driver to the computing device in response to a request from the computing device to transmit the device driver.

In one embodiment, the peripheral device periodically updates the device driver contained in the peripheral device.

### BRIEF DESCRIPTION OF THE DRAWINGS

The present invention is illustrated by way of example and not limitation in the figures of the accompanying drawings. The accompanying drawings merely represent one or more possible embodiments of the invention. The same numbers are used throughout the figures to reference like components and/or features.

FIG. 1 illustrates exemplary peripheral devices coupled to communicate with a computer system.

FIG. 2 is a block diagram showing pertinent components of an exemplary peripheral device.

FIG. 3 is a block diagram showing pertinent components of an exemplary printer.

FIG. 4 is a flow diagram illustrating a procedure for providing a computer with a driver.

FIG. 5 illustrates a network environment in which the methods and systems described herein may be implemented.

FIG. 6 is a flow diagram illustrating a procedure for updating a peripheral driver and communicating the peripheral driver to a computer.

### DETAILED DESCRIPTION

The present invention provides a driver contained in a peripheral device that can be communicated to a computing device coupled to the peripheral device. Once the peripheral device is coupled to the computing device, the peripheral device notifies the computing device that it has a built-in driver and offers to provide the built-in driver to the computing device. If the computing device receives and installs the driver, the computing device can communicate with the peripheral device and, for example, send requests to the peripheral device for processing. The process of notifying the computing system of the built-in driver and providing the driver to the computing device can be performed automatically without requiring any user intervention. Further, the process may be transparent to the user of the peripheral device and the computing device. Merely coupling the peripheral device to the computing device can initiate the above process, thereby simplifying the process of configuring a peripheral device to communicate with a computing device.

A peripheral device is any type of device that can be coupled to a computer. Example peripheral devices include, without limitation, a scanner, a printer, a multi-function device (also referred to as an “all-in-one” device), a digital sender, a camera, a keyboard, a mouse, a CD player, a DVD player and a peripheral storage device (such as a hard drive, CD-ROM, or tape drive). Peripheral devices can be coupled to the computer via any type of bidirectional communication link, including wired or wireless communication links. Example communication links include network communication links, serial communication links and parallel communication links. The communication links may utilize any type of communication medium and any communication protocol. Different peripheral devices may utilize different communication media and/or different communication protocols to communicate with a computer.

A computing device is any device or system capable of executing instructions (e.g., executing instructions contained in a device driver) and communicating with a peripheral device. A particular computing device may contain one or more processors or other processing devices. A computing device may also be referred to as a “computer” or a “computing system”.

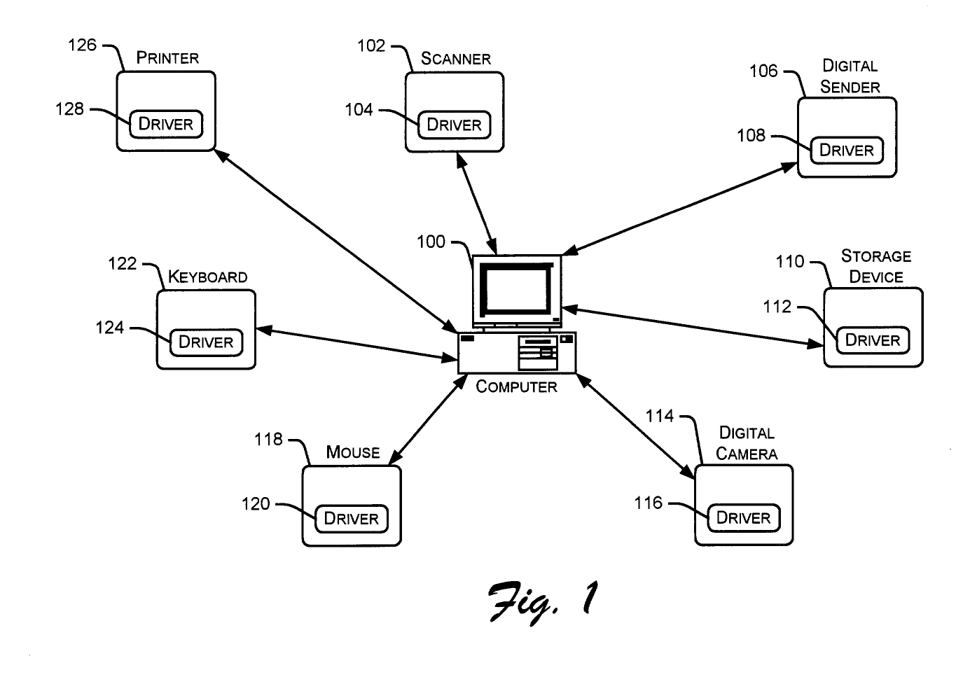

FIG. 1 illustrates exemplary peripheral devices coupled to communicate with a computer 100. In a particular embodiment, any number of peripheral devices may be coupled to the computer 100. A scanner 102 is coupled to computer 100 and includes a built-in scanner driver 104. A built-in driver may also be referred to as a “device driver”. As mentioned above, a built-in driver is a program that controls one or more devices. In the example of FIG. 1, built-in scanner driver 104 provides for the control of scanner 102. Built-in scanner driver 104 functions as a translator between scanner 102 and one or more application programs on computer 100 that use the scanner. Built-in scanner driver 104 may be stored in any type of memory device or storage device, such as a read only memory (ROM), a random access memory (RAM) or a hard disk drive.

Computer 100 is also coupled to a digital sender 106, which includes a built-in digital sender driver 108. As discussed above, built-in digital sender driver 108 is used by computer 100 to control operation of digital sender 106. A storage device 110 is also coupled to computer 100. Storage device 110 includes a built-in storage device driver 112. Storage device 110 may be a hard disk drive, CD-ROM drive, tape drive, or any other storage mechanism.

Computer 100 is further coupled to a digital camera 114 that contains a built-in camera driver 116 and a mouse 118, which contains a built-in mouse driver 120. Additionally, a keyboard 122 (including a built-in keyboard driver 124) and a printer 126 (including a built-in printer driver 128) are coupled to computer 100.

Although not shown in FIG. 1, each peripheral device 102, 106, 110, 114, 118, 122 and 126 includes a communication interface that allows the peripheral device to communicate with computer 100. Computer 100 has one or more similar interfaces that allow the computer to communicate with one or more peripheral devices. Two or more peripheral devices may share a common communication link to computer 100.

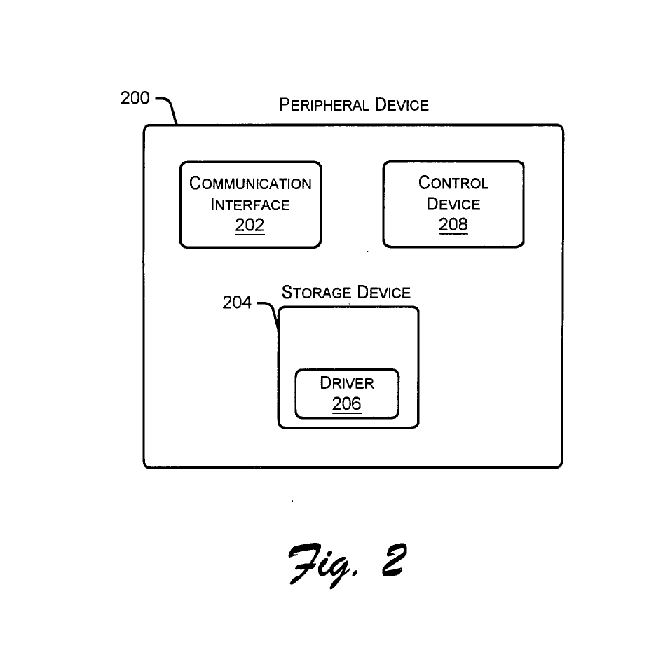

FIG. 2 is a block diagram showing pertinent components of an exemplary peripheral device 200. Peripheral device 200 includes a communication interface 202 that is capable of exchanging data with a computing device or other devices coupled to the peripheral device. A storage device 204 in peripheral device 202 includes a device driver 206 associated with the peripheral device. Storage device 204 may store additional data used by peripheral device 202. Storage device 204 may be a volatile or a nonvolatile memory device, such as a random access memory (RAM), read-only memory (ROM), or a hard disk drive. In a particular embodiment, storage device 204 is a rewritable memory device, such as an electronically erasable programmable read only memory (EEPROM).

A control device 208 in peripheral device 202 controls the operation of the peripheral device, such as controlling communications with other devices and controlling the transmission of device driver 206 to one or more computing systems. Control device 208 may be, for example, a microprocessor, a microcontroller, a programmable logic device, or any other device capable of controlling the transmission of device driver 206 to one or more computing systems.

Although communication interface 202, storage device 204 and control device 208 are illustrated in FIG. 2 as separate components, any of these components can be combined into a single component.

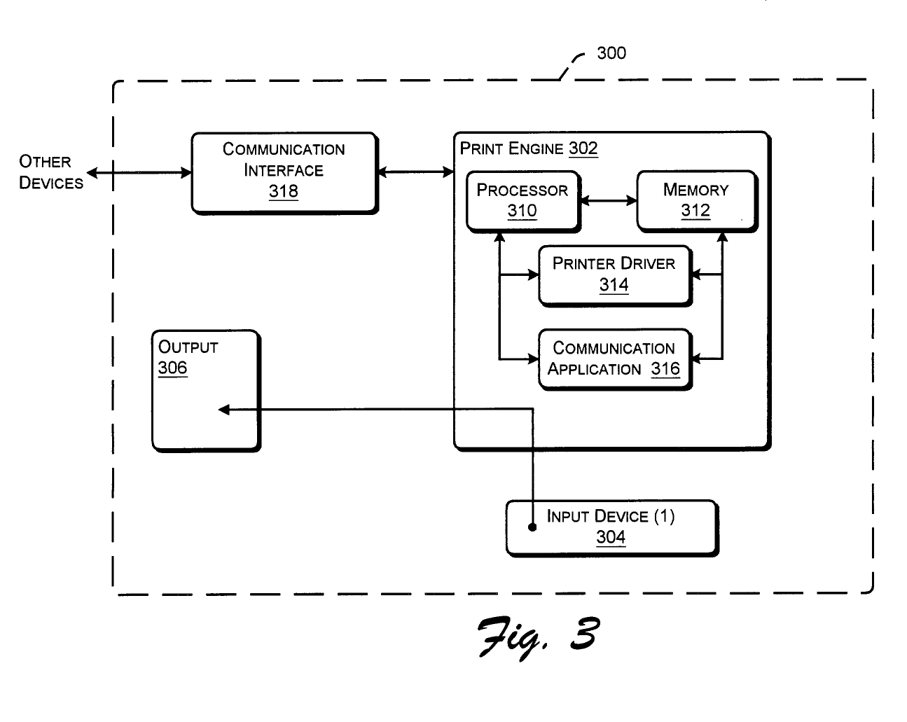

FIG. 3 is a block diagram showing pertinent components of an exemplary printer 300 containing a built-in printer driver. Similar components may be included in other types of peripheral devices containing built-in device drivers. As used herein, a printer refers to any type of device that can generate an image (e.g., a letter, a picture, a drawing, etc.) on any type of print media, such as paper, cardstock, plastic, or fabric. Example devices include impact printers, non-impact printers, digital copiers, analog copiers, facsimile machines, press machines, silk screen machines, etc. Printers can produce images in any of a wide variety of conventional print media (paper, plastic, fabric, etc.). However, for ease of discussion, printers are discussed herein in the context of printing on paper. A printer may also be referred to herein as a “printing device”.

Printer 300 includes a print engine 302 and an input device 304. The printer 300 also has at least one output device 306. During a printing operation, a sheet of paper is provided to print engine 302 from input device 304 or from a direct paper feed (e.g., an external direct-feed tray). As the sheet of paper passes through the print engine 302, the appropriate information is printed on the paper. The paper can be printed in any of a wide variety of conventional manners, such as a conventional laser printing process or a conventional inkjet printing process. After printing, the sheet of paper is output directly by print engine 302 to output 306, such as an output bin (or output tray), or other device capable of outputting the sheet of paper from the printer. Output 306 may be coupled to another device (not shown) that further processes the sheet of paper.

Input device 304 represents a variety of print medium sources and preprocessing devices. Example input devices include: a device with one or more paper trays for supplying one or more sizes or types of paper to print engine 302; a pre-processing device to put a “stamp” on each sheet of paper prior to printing (such as physically adding a stamp to the sheet of paper or adding a graphical image or text to the information for each page); a paper separating device that separates fan-folded media into separate sheets or to cut a sheet of paper from a roll of paper; a device to affix another piece of paper to the sheet for printing (e.g., a Post-It® Note); a hole punching device to punch hole(s) in each sheet of paper; or a scanning device, such as to obtain a serial number or other identifier from a sheet of paper to verify that pre-printed media is oriented correctly for printing:

Print engine 302, input device 304, and output device 306 can communicate with one another, transferring control information and data as necessary. Such communication may occur directly between two devices, or may be routed through print engine 302. Printer 300 includes additional components, such as a print head or other mechanism for producing the data to be printed on the sheet of paper in print engine 302.

Print engine 302 includes a processor 310 and a memory/storage device 312. Processor 310 controls the transfer of paper through printer 300, including communication of information to the input device 304 and the output device 306. Processor 310 may also communicate information to other devices coupled to printer 300. Processor 310 may be any type of microprocessor or microcontroller capable of performing the operations necessary to control the operation of printer 300. Alternatively, processor 310 may be replaced by an ASIC (application specific integrated circuit) or other customized device capable of controlling the printer 300.

Memory 312 is a volatile and/or nonvolatile memory, such as a RAM, a ROM, an EEPROM, or a magnetic or optical storage device. Memory 312 stores various information generated and/or used during the operation of the printer 100. Although memory 312 is illustrated as being separate from processor 312, all or part of memory 312 may be incorporated into processor 312.

Print engine 102 also contains a printer driver 314, which provides the basic functionality required for a computer to properly process print jobs for the printer. Printer driver 314 may be stored in memory 312 or another nonvolatile storage device. In one embodiment, printer driver 314 is stored in a Flash EEPROM, which allows the printer driver to be updated periodically. In another embodiment, printer driver 314 is stored on a hard disk drive contained within the printer 300.

Print engine 302 also includes a communication application 316, which may be stored in memory 312 or another storage device. Communication application 116 is executed by processor 312 or another processor (not shown) in printer 300. Communication application 316 allows printer 300 to communicate with other devices, such as other printers, computing devices, web servers, and the like. Printer 300 may be coupled to a network, thereby allowing other devices on the network to communicate with printer 300 via communication application 316.

In an alternate embodiment, printer driver 314 and/or communication application 316 are not located in print engine 302. For example, printer driver 314 and/or communication application 316 may be part of a separate module in the printer that includes a processor and a memory or other storage device.

A communication interface 318 is coupled to the print engine 302 and allows the print engine to communicate with other devices, such as other printers, computers or other media processing devices (e.g., staplers, binders, or sorters) coupled to the printer 300. In a particular embodiment, communication interface 318 includes a network interface that permits communication between print engine 302 and other devices coupled to a common network. In other embodiments, communication interface may communicate via a parallel connection, a serial connection, a universal serial bus (USB) connection, or a wireless (e.g., infrared or radio frequency) connection. Although the communication interface 318 is illustrated in FIG. 3 as a separate component, in alternate embodiments, the communication interface 318 is integrated into the print engine 302. A particular printer may include any number of communication interfaces using any type of communication medium and any communication protocol.

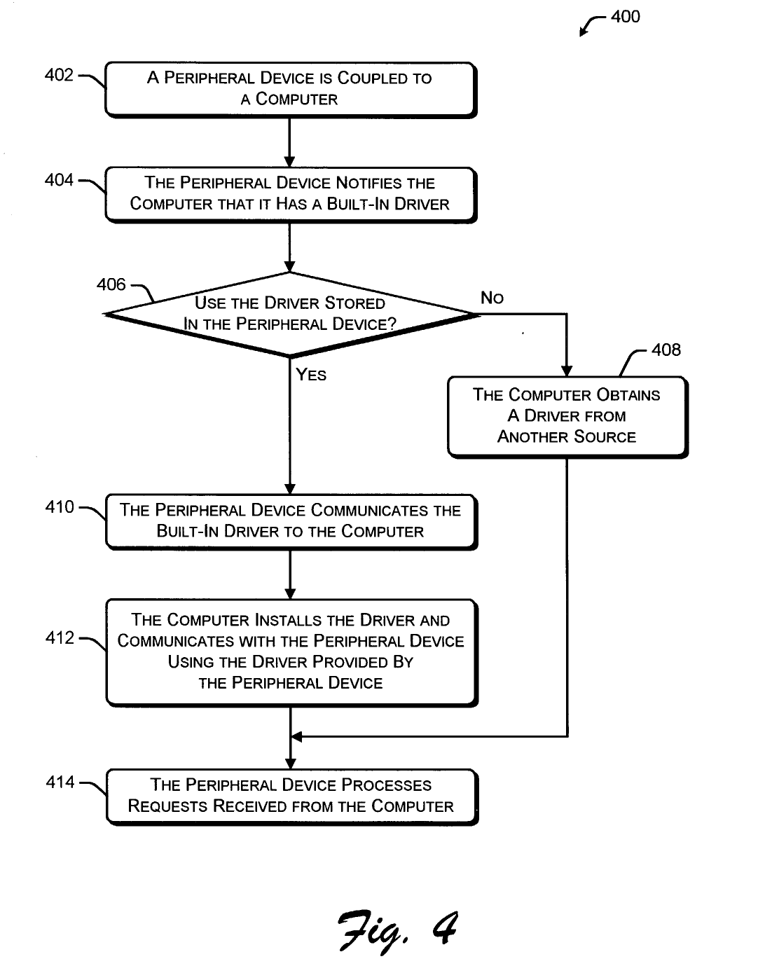

FIG. 4 is a flow diagram illustrating a procedure 400 for providing a computer with a device driver. Initially, a peripheral device is coupled to a computer (block 402). The peripheral device can be coupled to the computer using, for example, a parallel communication cable or a USB communication cable. Once powered-on, the peripheral device notifies the computer that it has a built-in device driver (block 404). Next, the computer determines whether to use the device driver stored in the peripheral device (block 406). If the computer decides not to use the device driver stored in the peripheral device, the computer obtains an appropriate device driver from another source (block 408). For example, the computer may download a device driver from a manufacturer's web site or retrieve a device driver from another computer system.

If the computer decides to use the device driver stored in the peripheral device, the peripheral device communicates the device driver to the computer (block 410). The computer then installs the device driver and is able to communicate with the peripheral device using the device driver provided by the peripheral device (block 412). The peripheral device then processes various requests received from the computer (block 414).

In an alternate embodiment, the peripheral device automatically communicates the device driver to the computer. The computer may later update the device driver. This embodiment ensures that the peripheral device is operable shortly after it is coupled to the computer without requiring any user actions to identify, select, install, or configure a device driver in the computer.

The device driver stored in the peripheral device may be a complete device driver or may contain a reduced set of functions, such as a basic set of operations. A reduced set of functions simplifies the device driver and reduces the storage space required to store the device driver in the peripheral device. The basic set of operations allow the peripheral device to handle basic tasks until a complete device driver is installed in the computer.

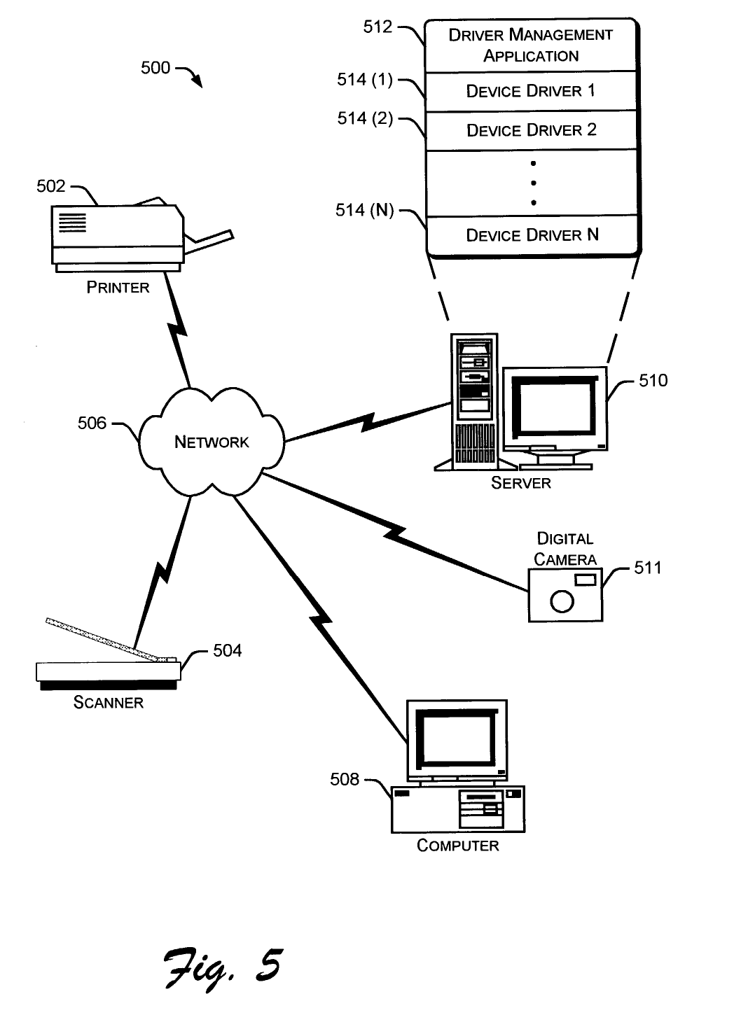

FIG. 5 illustrates a network environment 500 in which the methods and systems described herein may be implemented. A printer 502, a scanner 504 and a digital camera 511 are coupled to a network 506, thereby allowing the devices to communicate with one another and with other systems coupled to the network. Network 506 can be any type of data communication network, such as a Local Area Network (LAN), a Wide Area Network (WAN), or the Internet. In this example, printer 502, scanner 504 and digital camera 511 each contain a built-in device driver as described herein.

A computer 508 and a server 510 are also coupled to network 506. Computer 508 is capable of sending requests, such as print jobs, across network 506 to printer 502 and other devices coupled to the network. A device driver installed in computer 508 allows applications executing on computer 508 to communicate with printer 502, scanner 504 and digital camera 511. Server 510 includes a driver management application 512 that organizes and manages various device drivers 514 used by computers to communicate with various peripheral devices. Device drivers 514 may be received from peripheral devices 502, 504 and 511, or may be downloaded by a computer, such as computer 508. Peripheral devices 502, 504 and 511 may periodically download updated device drivers 514 from server 510 and replace the device driver stored in the peripheral device with the downloaded device driver.

Although FIG. 5 illustrates three peripheral devices 502, 504 and 511, one computer 508, and one server 510, a particular environment 500 may include any number of peripheral devices, any number of computers, and any number of servers coupled together via any number of networks having any topology and using any communication protocol.

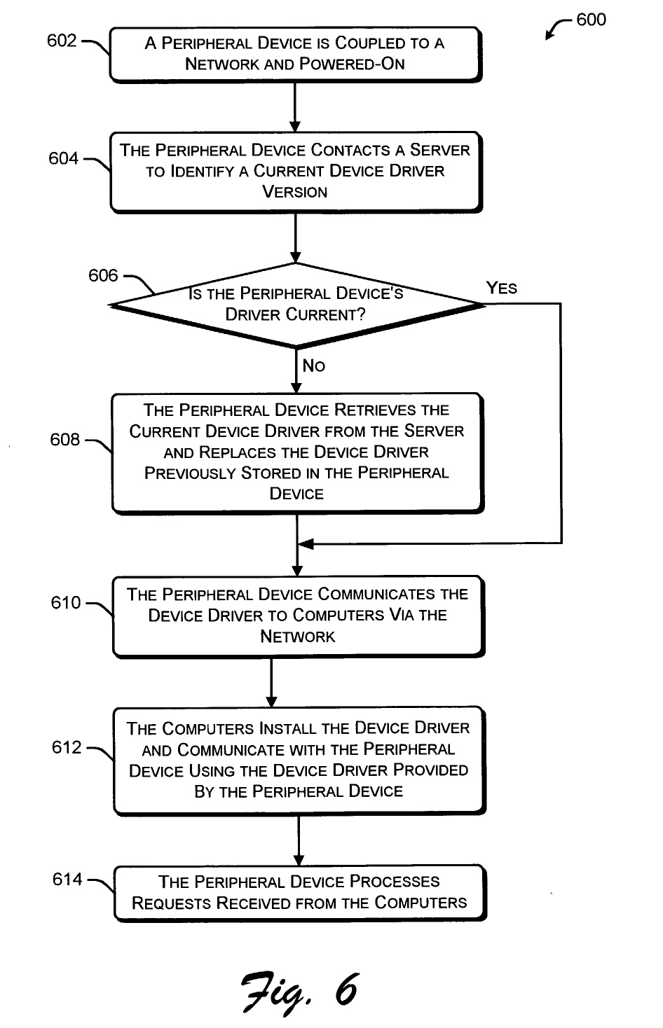

FIG. 6 is a flow diagram illustrating a procedure 600 for updating a device driver and communicating the device driver to a computer. Initially, a peripheral device is coupled to a network and powered-on (block 602). The peripheral device contacts a server coupled to the network to identify a current device driver version associated with the peripheral device (block 604). The peripheral device then determines whether the device driver stored in the peripheral device is current (block 606). If the device driver stored in the peripheral device is not current, the peripheral device retrieves the current device driver from the server and replaces the device driver previously stored in the peripheral device (block 608).

The peripheral device then communicates the device driver to one or more computers via a data communication network (block 610). The computers install the received device driver and communicate with the peripheral device using the device driver provided by the peripheral device (block 612). The peripheral device then processes requests received from the computers (block 614).

In a particular implementation, the peripheral device also communicates the device driver stored in the peripheral device to each new computer that is coupled to the network and requests to receive the device driver associated with the peripheral device. This allows newly connected computers to begin communicating with one or more peripheral devices via the network without requiring a user to install or configure any device drivers. Also, since the peripheral device maintains a current version of its own device driver, the computer receives a current version of the device driver directly from the peripheral device.

In a particular embodiment, the peripheral device also contains a help file (i.e., help instructions for the user of the peripheral device) that assists the user of the peripheral device and/or the computer coupled to the peripheral device to install device drivers, update device drivers, execute various peripheral device functions, or perform other operations. Additionally, the help file may provide a uniform resource locator (URL) that identifies a web page containing an updated device driver for the peripheral device. The information contained in the help file may be displayed on the computer and/or a display device (e.g., an LCD screen) on the peripheral device. Alternatively, the information contained in the help file may be printed for use by the operator of the peripheral device and/or computer. This help file may be stored in the computer or in a memory device in the peripheral device. The help file may be updated in a manner similar to the procedure for updating device drivers discussed above.

Thus, systems and methods for providing a device driver stored in a peripheral device to one or more computers are described herein. The described embodiments simplify the configuration of a peripheral device and a computer system by automatically installing the appropriate device driver on a computer coupled to the peripheral device.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method comprising:
a peripheral device notifying a computing device that the peripheral device contains a built-in device driver that can be communicated to the computing device; and
the peripheral device communicating the device driver to the computing device.

2. A method as recited in claim 1 further comprising coupling the peripheral device to the computing device prior to the peripheral device notifying the computing device.

3. A method as recited in claim 1 wherein the peripheral device communicates the device driver to the computing device in response to a request from the computing device to transmit the device driver.

4. A method as recited in claim 1 further comprising the computing device installing the device driver.

5. A method as recited in claim 1 further comprising:
the computing device installing the device driver; and
the computing device communicating with the peripheral device using the device driver.

6. A method as recited in claim 1 further comprising the computing device communicating requests to the peripheral device using information contained in the device driver.

7. A method as recited in claim 1 further comprising the peripheral device periodically updating the device driver contained in the peripheral device.

8. A method as recited in claim 1 further comprising the peripheral device displaying a help file to a user of the peripheral device.

9. A method as recited in claim 1 wherein the peripheral device is coupled to a network, the method further comprising the peripheral device communicating the device driver to each new computer that is coupled to the network.

10. A method comprising:
coupling a peripheral device to a first computing device, wherein the first computing device stores a current version of a device driver associated with the peripheral device;
determining whether the current version of the device driver associated with the peripheral device is more current than a device driver contained in the peripheral device;
if the current version of the device driver associated with the peripheral device is more current than the device driver contained in the peripheral device, then:
the peripheral device retrieving the current version of the device driver from the first computing device and replacing the previous device driver contained in the peripheral device with the current version of the device driver; and
the peripheral device communicating the current version of the device driver to a second computing device coupled to the peripheral device, wherein the second computing device communicates requests to the peripheral device;
if the device driver contained in the peripheral device is the current version of the device driver, then the peripheral device communicates the device driver to a second computing device coupled to the peripheral device, wherein the second computing device communicates requests to the peripheral device.

11. A method as recited in claim 10 further comprising the second computing device installing the device driver received from the peripheral device.

12. A method as recited in claim 10 further comprising:
the second computing device installing the device driver received from the peripheral device; and
the second computing device communicating with the peripheral device using information contained in the device driver received from the peripheral device.

13. A method as recited in claim 10 wherein the first computing device stores current versions of device drivers associated with a plurality of peripheral devices.

14. A method as recited in claim 10 wherein the device driver contained in the peripheral device is stored on a reprogrammable memory device.

15. A method as recited in claim 10 wherein the device driver contained in the peripheral device is stored on a hard disk drive in the peripheral device.

16. A peripheral device comprising:
a communication interface configured to exchange data with a computing device coupled to the peripheral device;
a storage device configured to store a device driver associated with the peripheral device; and
a control device coupled to the communication interface and the storage device, the control device configured to communicate with the computing device, wherein the control device is further configured to communicate the device driver associated with the peripheral device to the computing device.

17. A peripheral device as recited in claim 16 wherein the storage device is a non-volatile memory device.

18. A peripheral device as recited in claim 16 wherein the storage device is a programmable read-only memory device.

19. A peripheral device as recited in claim 16 wherein the storage device further contains a help file assists the user in retrieving a new device driver.

20. A peripheral device as recited in claim 16 wherein the storage device further contains a help file that identifies a location for retrieving a current device driver associated with the peripheral device.

21. A peripheral device as recited in claim 16 further comprising a communication application coupled to the control device and configured to communicate with the computing device to receive and updated version of the device driver.

22. A peripheral device as recited in claim 16 wherein the control device is a microprocessor.
